(19) United States
(12) Patent Application Publication
(10) Pub. No.: US 2026/0251998 A1
(43) Pub. Date: Aug. 27, 2026

(54) IMAGE FORMATION UNIT, IMAGE FORMATION APPARATUS, AND DEVELOPER CARTRIDGE

(71) Applicant: Oki Electric Industry Co., Ltd., Tokyo (JP)

(72) Inventor: Shingo SHIMADA, Tokyo (JP)

(73) Assignee: Oki Electric Industry Co., Ltd., Tokyo (JP)

(21) Appl. No.: 19/413,838

(22) Filed: Dec. 9, 2025

(30) Foreign Application Priority Data
Feb. 25, 2025 (JP) 2025-028279

(51) Int. Cl. G03G 15/08; G03G 21/16

(52) U.S. Cl. CPC G03G 15/0875; G03G 15/0886; G03G 21/1647; G03G 2221/1654

(57) ABSTRACT

A developer cartridge may be attachable to a main body and include: a supply port; an opening/closing member for the supply port; a restriction portion provided on a longitudinal one end side thereof and configured to restrict movement of the opening/closing member from a closed position to an open position; a first engagement portion provided on the longitudinal one end side; and a first contact portion provided on the longitudinal other end side. When the developer cartridge reaches a correct position, the first engagement portion engages with a second engagement portion of the main body and the restriction portion contacts a restriction release portion of the main body to release the restriction on the opening/closing member. When the developer cartridge reaches an incorrect position, the first contact portion contacts a second contact portion of the main body to maintain separation between the restriction portion and the restriction release portion.

### CROSS REFERENCE TO RELATED APPLICATIONS

This application claims priority based on 35 USC 119 from prior Japanese Patent Application No. 2025-028279 filed on February 25, 2025, entitled “IMAGE FORMATION UNIT, IMAGE FORMATION APPARATUS, AND DEVELOPER CARTRIDGE”, the entire contents of which are incorporated herein by reference.

### BACKGROUND

The disclosure may relate to an image formation unit, an image formation apparatus, and a developer cartridge.

In a related art, there is known an image formation unit of an image formation apparatus that includes: a main body provided with a reception port (inlet port) for receiving developer; and a developer cartridge detachably attachable to the unit main body and provided with a supply port for supplying the developer to the main body. As such an image forming unit, an arrangement is known in which a shutter is provided at the supply port of a developer cartridge to open and close the supply port. After the developer cartridge is attached to the main body, the shutter is moved to an open position (i.e., the shutter is opened), thereby allowing the developer to be supplied from the supply port to the reception port (see, for example, Patent Document 1).

Patent Document 1: Japanese Patent Application Publication No. 2009-175309

### SUMMARY

However, in such an image formation unit, a configuration may be considered in which the movement of the shutter from the closed position to the open position is restricted by a restriction portion, and the restriction is released when the restriction portion comes into contact with a restriction release portion of the main body as the developer cartridge is attached onto the main body. In such a configuration, even when the developer cartridge is incorrectly attached to the main body, the restriction portion may come in contact with the restriction release portion of the main body, thereby releasing the restriction.

In this case, the shutter opens while the reception port and the supply port are separated and not connected to each other, which may cause the developer to leak from the supply port and contaminate the surrounding areas of the supply port.

An object of one or more embodiments of the disclosure may be to propose an image formation unit, an image formation apparatus, and a developer cartridge that can reduce contamination by developer.

A first aspect of the disclosure may be an image formation unit that may include: a main body; and a developer cartridge that is configured to be detachably attached to the main body. The developer cartridge includes: a supply port provided at one end side of the developer cartridge in an orthogonal direction orthogonal to a longitudinal direction and configured to supply a developer stored in the developer cartridge; an opening/closing member configured to open and close the supply port; a restriction portion provided on the one end side in the orthogonal direction of the developer cartridge and configured to restrict movement of the opening/closing member from a closed position to an open position; a first engagement portion provided on one end side in the longitudinal direction of the developer cartridge; and a first contact portion provided on the other end side in the longitudinal direction of the developer cartridge. The main body includes: a reception port provided at a position where the reception port is connected to the supply port in a state where the developer cartridge is attached to the main body and configured to receive the developer from the supply port; a second engagement portion provided at a position opposite the longitudinal one end side of the developer cartridge, the second engagement portion being configured to engage with the first engagement portion of the developer cartridge when the developer cartridge reaches a correct position during attachment of the developer cartridge to the main body; a restriction release portion configured to release the restriction on movement of the opening/closing member by contacting the restriction portion when the developer cartridge reaches the correct position; and a second contact portion provided at a position opposite the longitudinal other end side of the developer cartridge, the second contact portion being configured to contact the first contact portion of the developer cartridge when the developer cartridge reaches an incorrect position during attachment of the developer cartridge to the main body, thereby maintaining separation between the restriction portion and the restriction release portion.

A second aspect of the disclosure may be an image formation apparatus including the image formation unit according to the above described first aspect. A third aspect of the disclosure may be a developer cartridge that is detachable from a main body. The developer cartridge includes: a supply port provided at one end side of the developer cartridge in an orthogonal direction orthogonal to a longitudinal direction and configured to supply a developer stored in the developer cartridge; an opening/closing member configured to open and close the supply port; a restriction portion provided on the one end side in the orthogonal direction of the developer cartridge and configured to restrict movement of the opening/closing member from a closed position to an open position; a first engagement portion provided on one end side in the longitudinal direction of the developer cartridge; and a first contact portion provided on the other end side in the longitudinal direction. The developer cartridge is configured, when the developer cartridge reaches a correct position during attachment of the developer cartridge to the main body, such that the first engagement portion engages with a second engagement portion provided on the main body and the restriction portion comes in contact with a restriction release portion provided on the main body to release the restriction on the movement of the opening/closing member. The developer cartridge is configured, when the developer cartridge reaches an incorrect position during attachment of the developer cartridge to the main body, such that the first contact portion comes in contact with a second contact portion provided on the main body, to maintain separation between the restriction portion and the restriction release portion.

According to at least one of the aspects described above, during attachment of the developer cartridge to the main body, if the developer cartridge reaches in the incorrect position, that is, if the developer cartridge is attached (mounted) incorrectly, the opening/closing member remains closed, to prevent the developer from leaking from the supply port.

According to at least one of the aspects described above, it is possible to realize an image formation unit, an image formation apparatus, and a developer cartridge that are capable of reducing contamination by developer.

### BRIEF DESCRIPTION OF DRAWINGS

FIG. 1 is a cross-sectional view illustrating a configuration of a print mechanism of an image formation apparatus.

FIG. 2 is a cross-sectional view illustrating an internal configuration of an image formation unit.

FIG. 3 is a perspective view illustrating an external configuration of the image formation unit.

FIG. 4 is a perspective view illustrating an external configuration (1) of a drum unit.

FIG. 5 is a perspective view illustrating an external configuration (2) of the drum unit.

FIG. 6 is a perspective view illustrating an external configuration (1) of a toner cartridge.

FIG. 7 is a perspective view illustrating an external configuration (2) of the toner cartridge.

FIGS. 8A and 8B are diagrams illustrating an operation (1) of installing the toner cartridge in a correct manner.

FIGS. 9A to 9D are diagrams illustrating an operation (2) of installing the toner cartridge in the correct manner.

FIGS. 10A to 10D are diagrams illustrating an operation of a rotation member of the toner cartridge and a supply port shutter that operates in conjunction with the rotation member.

FIGS. 11A to 11D are diagrams illustrating an operation of installing the toner cartridge in a manner (1) different from the correct installing manner.

FIGS. 12A to 12C are diagrams illustrating an operation of installing the toner cartridge in a manner (2) different from the correct installing manner.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### 1. Configuration of Print Mechanism of Image Formation Apparatus

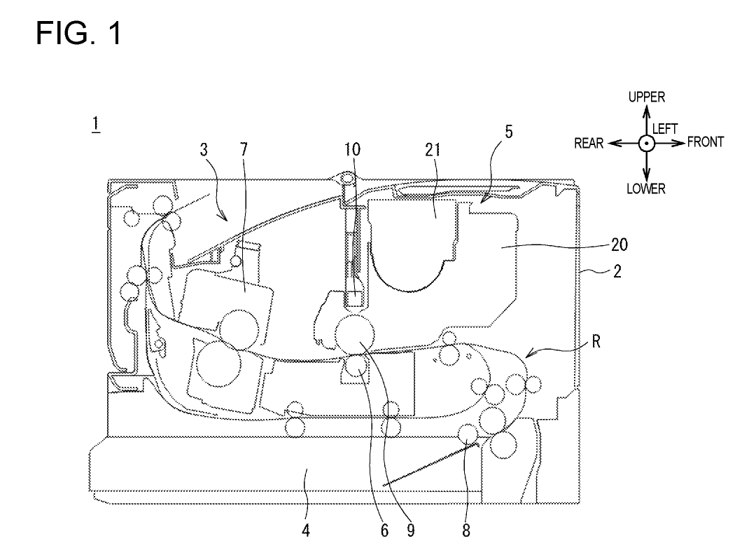

FIG. 1 is a diagram illustrating a configuration of a print mechanism of an image formation apparatus 1 according to a first embodiment. The image formation apparatus 1 is an electrophotographic printer, and includes a print mechanism inside a roughly box-shaped apparatus main body 2 for printing on a recording medium such as printing paper using toner as a developer. In the figure, the right, left, front, rear, top, and bottom sides of the apparatus main body 2 correspond respectively to the right, left, front, rear, top, and bottom sides of the image formation apparatus 1.

The top surface of the apparatus main body 2 is formed with a stacker 3 onto which recording media printed by the image formation apparatus 1 are discharged. Inside the apparatus main body 2, a paper feed cassette 4 for storing recording media is provided at the lower part. Inside the apparatus main body 2, a conveyance path R is formed which connects the paper feed cassette 4 and the stacker 3 and serves as a path for the recording media.

Inside the apparatus main body 2, an image formation unit 5, a transfer roller 6, and a fixation device 7 are arranged in this order along the conveyance path R from the upstream side, i.e., the side closer to the paper feed cassette 4), in the conveyance direction. Inside the apparatus main body 2, various rollers for conveying the recording medium along the conveyance path R are provided.

The paper feed cassette 4 is a component in which the recording media are to be stored. The paper feed cassette 4 includes a hopping roller 8 for feeding the stored recording media to the conveyance path R. The recording medium fed from the paper feed cassette 4 to the conveyance path R is transported along the conveyance path R to the image formation unit 5 and the transfer roller 6.

The image formation unit 5 includes a drum unit 20, which includes a photosensitive drum 9 serving as an image carrier, and a toner cartridge 21 that contains therein toner serving as a developer. The drum unit 20 is detachable from the apparatus main body 2 and is thus replaceable. The toner cartridge 21 is detachable from the drum unit 20 and is thus replaceable. The configuration of the image formation unit 5 is described in detail later. The transfer roller 6 is provided below the photosensitive drum 9 with the conveyance path R therebetween. An LED head 10 serving as an exposure device is provided above the photosensitive drum 9.

The LED head 10 exposes the surface of the photosensitive drum 9 based on print data. Accordingly, an electrostatic latent image is formed on the surface of the photosensitive drum 9. The image formation unit 5 develops the electrostatic latent image formed on the surface of the photosensitive drum 9 using the toner supplied from the toner cartridge 21. As a result, a developer image is formed on the surface of the photosensitive drum 9.

The transfer roller 6 transfers the developer image formed on the surface of the photosensitive drum 9 onto the recording medium when the recording medium passes between the photosensitive drum 9 and the transfer roller 6.

The fixation device 7 fixes the developer image transferred onto the recording medium to the recording medium by applying heat and pressure while conveying the recording medium through a nip portion between a heating member and a pressure member of the fixation device 7. The recording medium on which the developer image has been fixed by the fixation device 7 is discharged into the stacker 3.

### 2. Configuration of Image Formation Unit

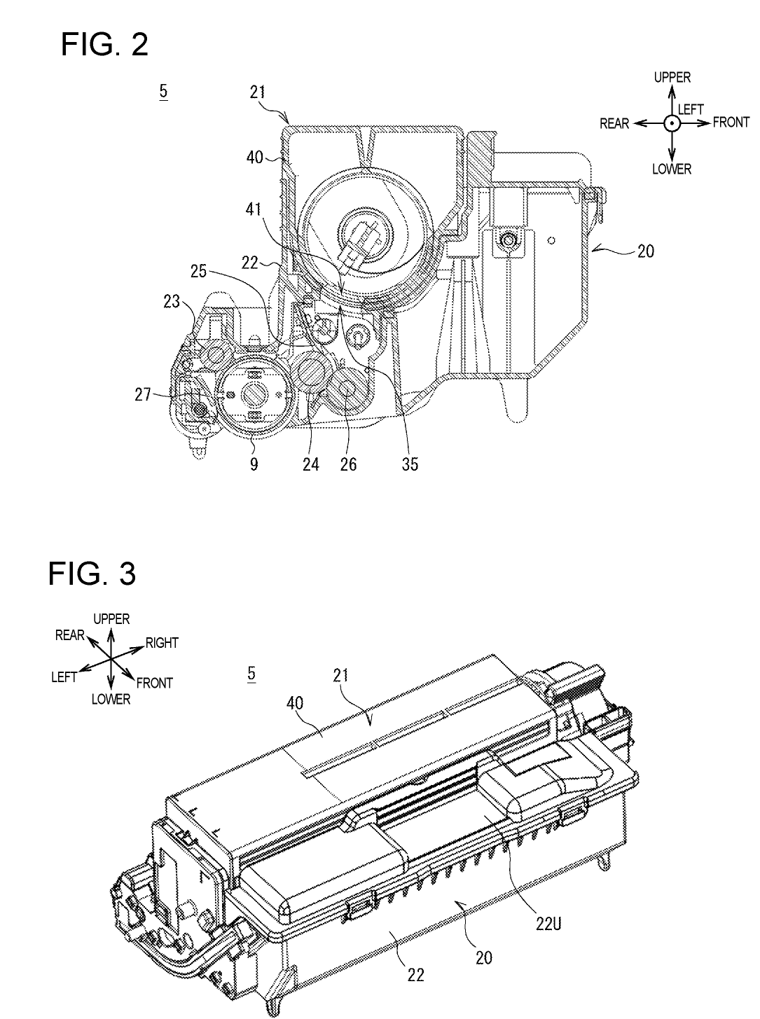

FIGS. 2 and 3 illustrate the configuration of the image formation unit 5. FIG. 2 is a side cross-sectional view of the image formation unit 5 with the left side surface thereof cut away. FIG. 3 is an external perspective view of the image formation unit 5 as viewed diagonally from the front left above. As illustrated in FIGS. 2 and 3, the image formation unit 5 is composed of the drum unit 20 and the toner cartridge 21.

The drum unit 20 includes a unit main body 22. The photosensitive drum 9 is provided inside the unit main body 22. The unit main body 22 is approximately rectangular and elongated in the left-right direction, which is the direction of the rotation axis of the photosensitive drum 9. The unit main body 22 is configured to be detachable from the apparatus main body 2 of the image formation apparatus 1. Inside the unit main body 22, a charging roller 23, a development roller 24, a development blade 25, a supply roller 26, and a cleaning blade 27 are further provided.

The charging roller 23 is a component that uniformly charges the surface of the photosensitive drum 9. The development roller 24 is a component that carries the toner and adheres the toner to the electrostatic latent image formed on the surface of the photosensitive drum 9, thereby developing the electrostatic latent image. The development blade 25 is a component that turns the toner carried on the development roller 24 into a thin layer. The supply roller 26 is a component that supplies the toner, supplied from the toner cartridge 21 to the drum unit 20, to the development roller 24. The cleaning blade 27 is a component that scrapes off, from the photosensitive drum 9, residual toner and other substances that remain on the photosensitive drum 9 without being transferred to the recording medium.

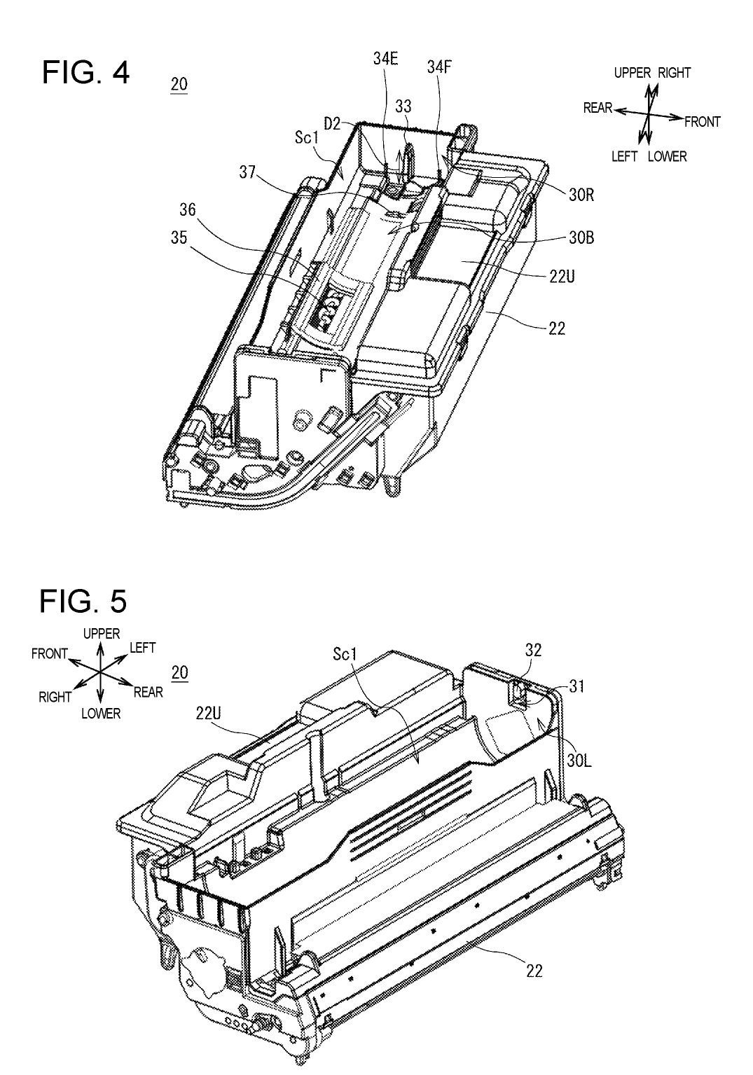

FIGS. 4 and 5 illustrate the external configuration of the drum unit 20 with the toner cartridge 21 removed. FIG. 4 is an external perspective view of the drum unit 20 as seen from the upper left oblique angle. FIG. 5 is an external perspective view of the drum unit 20 as seen from the upper rear right oblique angle.

As illustrated in FIGS. 4 and 5, the drum unit 20 includes an upper cover frame 22U that forms an upper part of the unit main body 22, which includes an installation space Sc1 for installing the toner cartridge 21 therein. The installation space Sc1 has a substantially rectangular parallelepiped shape elongated in the left-right direction with its upper side open, and is sized to accommodate the portion of the toner cartridge 21 excluding its upper end portion. The drum unit 20 is configured such that the toner cartridge 21 can be attached (mounted, installed) by inserting the toner cartridge 21 into the installation space Sc1.

The upper cover frame 22U includes a left end groove 31 formed on a left wall surface 30L located at the left end, which is one end in the longitudinal direction of the installation space Sc1. The left end side groove 31 extends downward from the upper end of the central part in the front-rear direction of the left wall surface 30L and is recessed one step relative to the left wall surface 30L. A left end protrusion 32 is provided inside of the left end groove 31 and has a substantially rectangular column shape that projects rightward. In other words, the left wall surface 30L includes the left end groove 31 formed in a U-shape at the upper end of the central portion in the front-rear direction.

The upper cover frame 22U includes a right wall surface 30R located at the right end, which is the other longitudinal end of the installation space Sc1. The right wall surface 30R includes a right end protrusion 33. The right end protrusion 33 has a rib-shape and projects leftward from the right wall surface 30R. The right end protrusion 33 extends upward from the vicinity of the lower end of the right wall surface 30R, along the central portion in the front-rear direction of the right wall surface 30R. The lower end of the right end protrusion 33 is located slightly above a bottom surface 30B located at a lower end of the installation space Sc1. In other words, a gap is provided between the lower end of the right end protrusion 33 and the bottom surface 30B of the installation space Sc1. An upper end of the right end protrusion 33 is located near the center portion in the vertical direction of the right wall surface 30R.

The right wall surface 30R is an inclined surface that is inclined so as to approach the left wall surface 30L as it extends downward.

The right wall surface 30R includes cartridge posture correction guides 34F and 34E. The cartridge posture correction guides 34F and 34E has a rib-shape and are provided in front and rear of the right end protrusion 33, sandwiching the right end protrusion 33 therebetween. Each of cartridge posture correction guides 34F and 34E protrudes toward the left from the right wall surface 30R and extends upward from the lower end of the right wall surface 30R. In other words, the cartridge posture correction guides 34F and 34E are formed on the right wall surface 30R so as to sandwich the right end protrusion 33 in the front-rear direction, which is orthogonal to the longitudinal direction of the installation space Sc1.

The cartridge posture correction guides 34F and 34E have the same shape, and the vertical length thereof is approximately half that of the right end protrusion 33. In other words, the upper ends of the cartridge posture correction guides 34F and 34E are located lower than the upper end of the right end protrusion 33.

Further, the amount by which the cartridge posture correction guides 34F and 34E protrude leftward from the right wall surface 30R is smaller than the amount by which the right end protrusion 33 protrudes. Furthermore, the upper ends of the cartridge posture correction guides 34F and 34E are located lower than the lower end of the left end protrusion 32 provided on the left wall surface 30L of the installation space Sc1. That is, the protrusion 32 is located upstream of the cartridge posture correction guides 34F and 34E in the insertion direction (attachment direction) of the toner cartridge 21.

Furthermore, the upper cover frame 22U includes a toner reception port 35 (a toner inlet port) for receiving the toner into the drum unit 20. The toner reception port 35 is located at a position on the rear side of the central portion in the left-right (longitudinal) direction of the bottom surface 30B. The bottom surface 30B is not flat but is formed in an arc shape recessed downward, when viewed in the longitudinal direction of the installation space Sc1, so as to conform to the shape of the bottom surface of the toner cartridge 21. An elastic seal member 36 is provided at the periphery of the toner reception port 35. In other words, the toner reception port 35 is surrounded by the elastic seal member 36.

The bottom surface 30B is provided with a stopper release protrusion 37. The stopper release protrusion 37 projects upward at a position between the toner reception port 35 and the right end protrusion 33, that is, in the vicinity of the right end of the bottom surface 30B. The drum unit 20 is configured as described above.

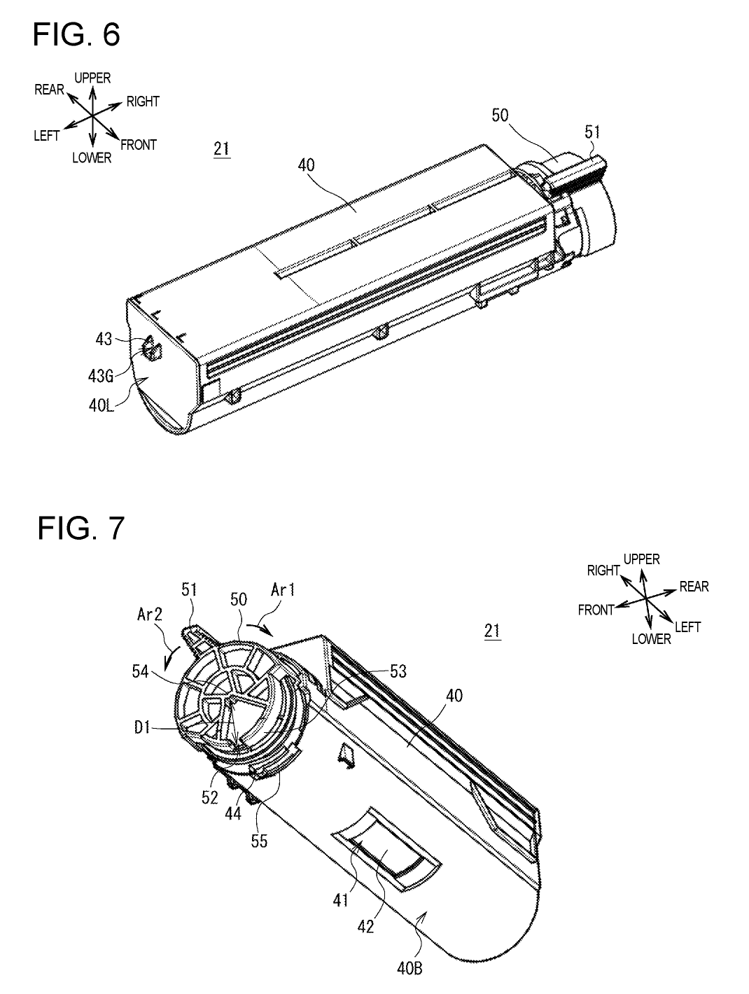

FIGS. 6 and 7 illustrate the external configuration of the toner cartridge 21. Note that in this disclosure, the directions (upper, lower, left and right) of the toner cartridge 21 are defined with reference to the orientation of the toner cartridge 21 when it is attached to the drum unit 20. FIG. 6 is an external perspective view of the toner cartridge 21 as seen from diagonally above the front left side. FIG. 7 is an external perspective view of the toner cartridge 21 as seen from diagonally below the right side.

As illustrated in FIGS. 6 and 7, the toner cartridge 21 includes a cartridge frame 40 having a generally rectangular parallelepiped shape that is elongated in the left-right direction, and a rotation member 50 having a generally cylindrical shape and rotatably provided at the right end of the cartridge frame 40.

The cartridge frame 40 is configured to accommodate therein the toner. An underside 40B of the cartridge frame 40 is not flat but is curved in an arc shape that is convex downward along the outer periphery of the rotation member 50 when viewed from the longitudinal direction of the cartridge frame 40.

Furthermore, the underside 40B of the cartridge frame 40 includes a toner supply port 41 to supply the toner contained in the cartridge frame 40 to the outside. The toner supply port 41 is located at a position on the rear side of the central portion in the left-right direction (longitudinal direction), that is, at a position opposite the toner reception port 35 of the drum unit 20 when the toner cartridge 21 is attached to the drum unit 20.

Furthermore, the toner supply port 41 is provided with a supply port shutter 42. The supply port shutter 42 is configured to move between a closed position to block (i.e., close) the toner supply port 41 and an open position to open the toner supply port 41. The supply port shutter 42 moves in conjunction with the rotation of the rotation member 50.

Specifically, when the rotation member 50 rotates in the direction of arrow Ar1 illustrated in FIG. 7, the supply port shutter 42 moves to the open position, and when the rotation member 50 rotates in the direction of arrow Ar2, which is the opposite direction to arrow Ar1, the supply port shutter 42 moves to the closed position. The direction of arrow Ar1 may be referred to as a shutter opening direction, and the direction of arrow Ar2 may be referred to as a shutter closing direction.

Furthermore, a left end protrusion 43, which projects leftward from the left side surface 40L of the cartridge frame 40, is provided in the vicinity of the upper end of the center portion in the front-rear direction. The left end protrusion 43 has a shape like a U-shape as seen in the longitudinal direction (left-right direction) of the cartridge frame 40. The left end protrusion 43 includes therein a groove, referred to as a left end groove 43G, extending from the tip of the left end protrusion 43 to the right.

The left end protrusion 43 is a portion that is inserted into the left end groove 31 of the drum unit 20 when the toner cartridge 21 is attached to the drum unit 20. Not that, when the left end protrusion 43 of the toner cartridge 21 is inserted into the left end groove 31 of the drum unit 20, the left end protrusion 32 formed inside the left end groove 31 is inserted into the left end groove 43G from the tip side of the left end protrusion 43 of the toner cartridge 21.

On the other hand, the rotation member 50 located at the right end of the cartridge frame 40 is provided with an operation lever 51 that protrudes from a predetermined location on the outer periphery of the rotation member 50 (on the upper side in FIG. 7). The toner cartridge 21 is configured such that the rotation member 50 is rotated by operating the operation lever 51.

The rotation member 50 includes a groove 52 (hereinafter referred to as a rotation member groove 52) formed on the outer periphery thereof at a position opposite the operation lever 51 (on the lower side in FIG. 7). The rotation member groove 52 extends leftward from the right end of the rotation member 50 in a direction parallel to the rotational axis of the rotation member 50. Upon attaching the toner cartridge 21 to the drum unit 20, the right end protrusion 33 of the drum unit 20 passes though the rotation member groove 52.

A portion of the outer periphery of the rotation member 50, located on the upstream side of and adjacent to the rotation member groove 52 in the shutter opening direction, serves as a rotation member engagement portion 53 configured to engage with the right end protrusion 33 of the drum unit 20.

As will be described in more detail later, the rotation member engagement portion 53 is a part or a component that is configured to prevent the toner cartridge 21 from detaching from the drum unit 20. Specifically, after the right end protrusion 33 of the drum unit 20 is passed through the rotation member groove 52 (i.e., entered inside the rotation member 50), and the rotation member 50 is then rotated in the shutter opening direction, the rotation member engagement portion 53 moves into the gap between the lower end of the right end protrusion 33 and the bottom surface 30B of the installation space Sc1 and thus engages with the right end protrusion 33, thereby fixing the toner cartridge 21 so that the toner cartridge 21 does not come off from the drum unit 20.

The rotation member 50 further includes a regulation rib 54 positioned closer to the center than the rotation member groove 52 (i.e., inward as seen from the rotation member groove 52) and extending in the direction of the rotational axis of the rotation member 50 (left-right direction). The regulation rib 54, which will be described in more detail later, is a part or a component that abuts against the upper end of the right end protrusion 33 that has passed through the rotation member groove 52 when the toner cartridge 21 is attempted to be inserted into the installation space Sc1 in an incorrect orientation, thereby preventing the toner cartridge 21 from being inserted any further.

The distance D1 from the rotation member groove 52 to the restriction rib 54 is slightly greater than the vertical length D2 (see FIG. 4) of the right end protrusion 33.

A stopper 55 that extends in the shutter opening direction is provided on the outer periphery of the rotation member 50, at a position spaced away toward the left side from the rotation member engagement portion 53. The stopper 55 is a part or a component that is elastically deformable in the radial direction of the rotation member 50. The stopper 55 is configured to prevent the rotation member 50 from rotating any further in the shutter opening direction indicated by arrow Ar1, when the tip portion of the stopper 55 comes in contact with a stopper contact portion 44 provided on the right end (in the vicinity of the rotation member 50) of the bottom surface 40B of the cartridge frame 40.

That is, as illustrated in FIG. 7, when the tip portion of the stopper 55 of the rotation member 50 abuts against the stopper contact portion 44 of the cartridge frame 40, the supply port shutter 42 cannot be moved to the open position. In this state, the rotation member 50 is in a rotational position that allows the right end protrusion 33 of the drum unit 20 to pass through the rotation member groove 52 when the toner cartridge 21 is attached to the drum unit 20.

Note that in the state the toner cartridge 21 is not attached to the drum unit 20, the tip portion of the stopper 55 of the rotation member 50 is in contact with the stopper contact portion 44 of the cartridge frame 40, so that the toner supply port 41 is closed (blocked) by the supply port shutter 42.

On the other hand, when the toner cartridge 21 is attached to the drum unit 20, the stopper 55 comes into contact with the stopper release protrusion 37 (see FIG. 4) of the drum unit 20 and is pushed upward by the stopper release protrusion 37, causing the stopper 55 to elastically deform.

When the stopper 55 is elastically deformed in this manner, the tip portion of the stopper 55 disengages upward from the stopper contact portion 44 (i.e., toward the inside of the rotation member 50), allowing the rotation member 50 to rotate together with the stopper 55 in the shutter opening direction. In other words, by operating the operation lever 51, the rotation member 50 is rotated in the shutter opening direction. The toner cartridge 21 is configured as described above.

### 3. Attachment of Toner Cartridge

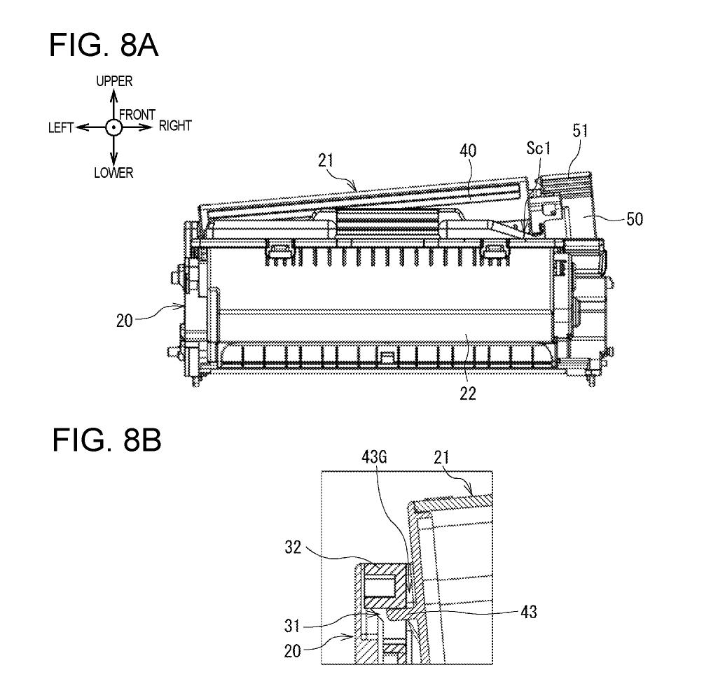

Next, the operation of attaching the toner cartridge 21 to the drum unit 20 is described in detail. FIG. 8A is a front view illustrating the toner cartridge 21 and the drum unit 20 when the toner cartridge 21 begins to be attached to the drum unit 20, as seen from the front.

FIG. 8A illustrates the correct way to attach the toner cartridge 21 to the drum unit 20. In the correct attachment procedure, as illustrated in FIG. 8A, a user inserts the toner cartridge 21 into the installation space Sc1 of the drum unit 20 while holding the toner cartridge 21 in a tilted position such that the left end, which is one end in the longitudinal direction, is positioned lower than the right end, which is the other longitudinal end. In other words, the toner cartridge 21 is inserted in a tilted orientation so that the left end of the cartridge is inserted into the installation space Sc1 before the right end of the toner cartridge 21.

This is because, upon attaching the toner cartridge 21 to the drum unit 20, the left end protrusion 32 of the drum unit 20 is first inserted into the left end groove 43G of the toner cartridge 21, as illustrated in FIG. 8B, which is an enlarged cross-sectional view of the area around the left end protrusion 32 of the drum unit 20 as seen from the front.

Note that, in order to insert the left end protrusion 32 of the drum unit 20 into the left end groove 43G of the toner cartridge 21, the toner cartridge 21 is first moved to the right so that the left end groove 43G of the toner cartridge 21 is positioned to the right of the left end protrusion 32 of the drum unit 20. Then, the left end of the toner cartridge 21 is lowered until the left end groove 43G of the toner cartridge 21 faces the left end protrusion 32 of the drum unit 20, after which the toner cartridge 21 is moved to the left.

In this manner, the toner cartridge 21 is inserted into the installation space Sc1 of the drum unit 20 in a tilted posture, with the left end side being lower than the right end side, and then the left end protrusion 32 of the drum unit 20 is inserted into the left end groove 43G of the toner cartridge 21.

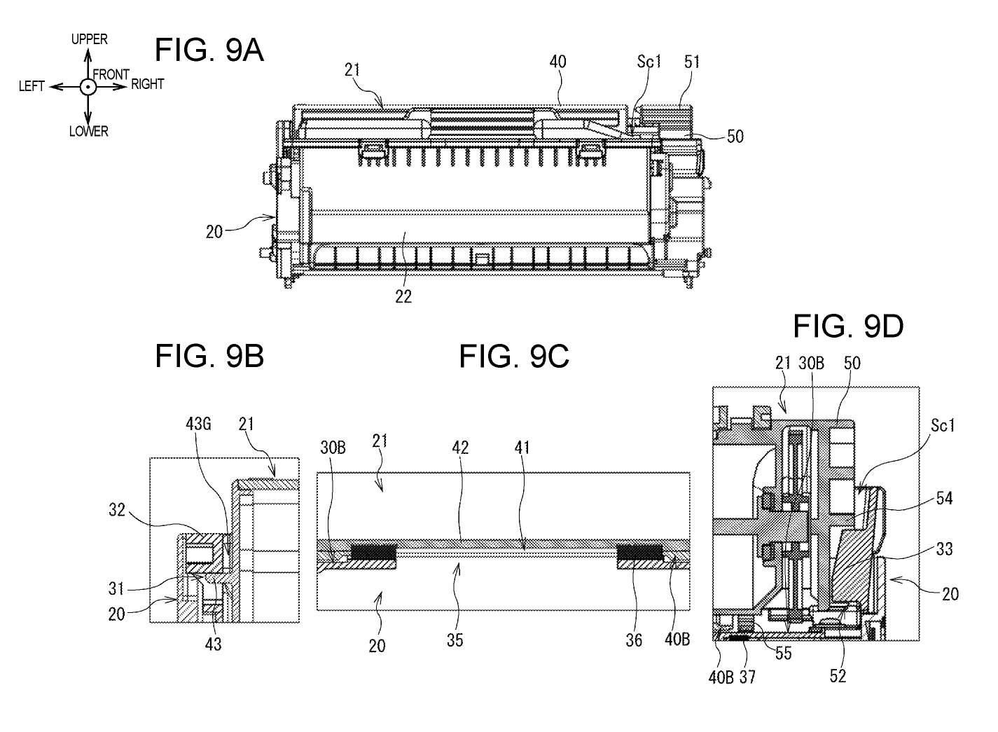

After the left end protrusion 32 of the drum unit 20 is inserted into the left end groove 43G of the toner cartridge 21 in this manner, the toner cartridge 21 is further inserted by lowering the right end side until a position where all portions except the upper end portion are accommodated in the installation space Sc1 (i.e., a fully inserted position), as illustrated in FIG. 9A.

When the toner cartridge 21 is inserted to the fully inserted position in this manner, as illustrated in FIG. 9B, the left end protrusion 32 of the drum unit 20 is inserted inside the left end protrusion 43 of the toner cartridge 21 (i.e., is inserted into the left end groove 43G).

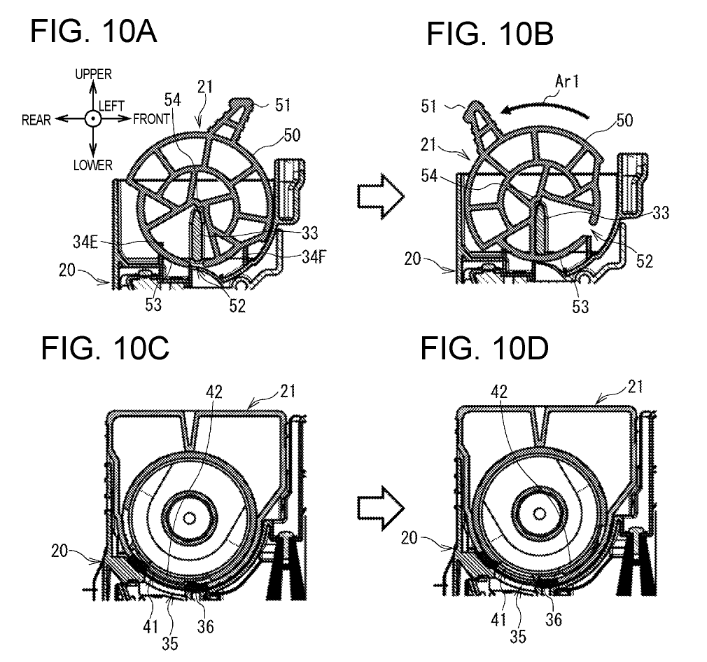

The fully inserted position of the toner cartridge 21 is illustrated in FIG. 9A to 9D and FIGS. 10A and 10C. Note that FIG. 9C is an enlarged cross-sectional view illustrating the area around the toner reception port 35 of the drum unit 20 as seen from the front. FIG. 10C is an enlarged cross-sectional view illustrating the area around the toner reception port 35 of the drum unit 20 as viewed from the left. In the fully inserted position of the toner cartridge 21, as illustrated in FIGS. 9C and 10C, the toner supply port 41 provided on the bottom surface 40B (FIG. 9C) of the toner cartridge 21 reaches a position where the toner supply port 41 comes in contact with (or is in proximity of) the toner reception port 35 provided on the bottom surface 30B (FIG. 9C) of the drum unit 20. In the fully inserted position, the toner supply port 41 is closed by the supply port shutter 42. In the fully inserted position, the elastic seal member 36 provided surrounding the toner reception port 35 comes in contact with the bottom surface 40B of the toner cartridge 21, so that the toner supply port 41 and the toner reception port 35 are connected without any gaps.

Note that FIG. 9D is an enlarged cross-sectional view illustrating the area around the right end protrusion 33 of the drum unit 20 as seen from the front, and FIG. 10A is a side view of the rotation member 50 of the toner cartridge 21 as seen from the left. As illustrated in FIGS. 9D and 10A, in the fully inserted position, the right end protrusion 33 of the drum unit 20 has passed through the groove 52 of the rotation member 50 of the toner cartridge 21 and been inserted in the rotation member 50. In the fully inserted position, the upper end of the right end protrusion 33 of the drum unit 20 and the restriction rib 54 provided on the inner side of the rotation member 50 are in a positional relationship where they do not come into contact with each other.

Furthermore, in the fully inserted position, as illustrated in FIG. 9D, the stopper release protrusion 37 provided on the bottom surface 30B of the drum unit 20 abuts against the stopper 55 provided on the bottom surface 40B of the toner cartridge 21, causing the stopper 55 to elastically deform, allowing the rotation member 50 of the toner cartridge 21 to be rotated in the shutter opening direction by the operation lever 51.

As described above, first, the toner cartridge 21 is inserted into the installation space Sc1 in the tilted position, with the left end being lower than the right end of the toner cartridge 21, as illustrated in FIGS. 8A and 8B. With this, the left end protrusion 32 of the drum unit 20 is inserted into the inside of the left end protrusion 43 of the toner cartridge 21 (into the left end groove 43G). Thereafter, the right end of the toner cartridge 21 is lowered into the installation space Sc2 until the toner cartridge 21 is inserted to the fully inserted position (i.e., the position illustrated in FIGS. 9A to 9D) in which the stopper 55 of the toner cartridge 21 abuts against the stopper release protrusion 37 of the drum unit 20. The fully inserted position of the toner cartridge 21 (see FIGS. 9A to 9D) is referred to as a correct insertion position or a correct position.

After the toner cartridge 21 has been inserted to the fully inserted position (i.e., in the correct insertion position), the attachment of the toner cartridge 21 is completed by rotating the rotation member 50 of the toner cartridge 21 in the shutter opening direction using the operation lever 51, as illustrated in FIG. 10B.

In this state, the engagement portion 53 of the rotation member 50 enters into the gap between the lower end of the right end protrusion 33 of the drum unit 20 and the bottom surface 30B of the installation space Sc1, and engages with the right end protrusion 33, thereby fixing the toner cartridge 21 to the drum unit 20.

In this state, as illustrated in FIG. 10B, the supply port shutter 42 of the toner cartridge 21 moves to the open position, thereby opening the toner supply port 41 and allowing the toner to be supplied through the toner supply port 41 to the toner reception port 35. When the toner cartridge 21 is attached to the drum unit 20 in the correct attachment manner, the operation proceeds as described above.

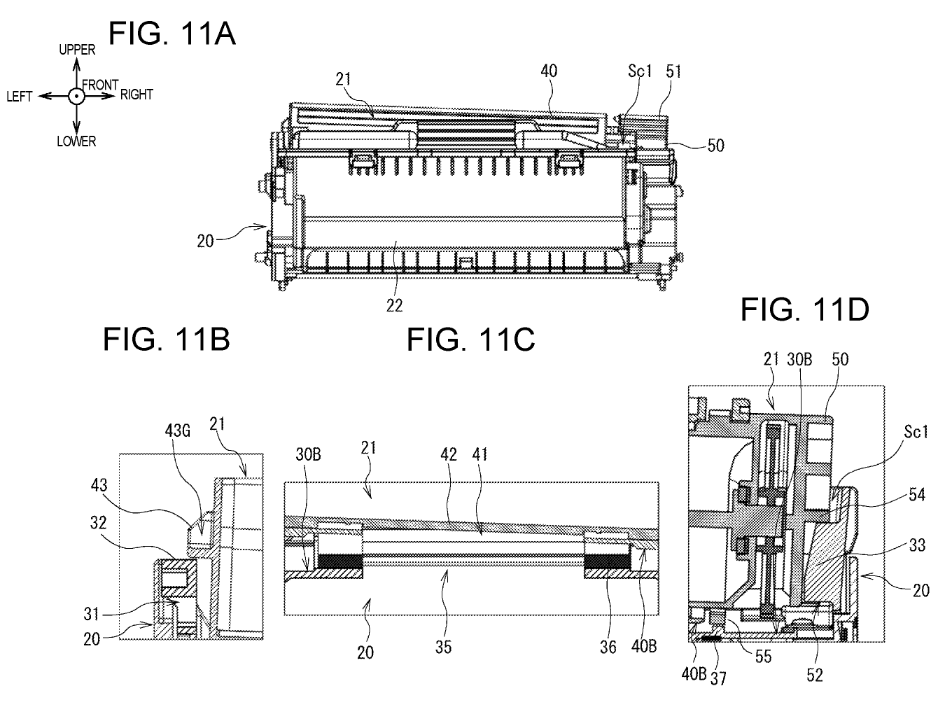

Next, operations are described when an attempt is made to attach the toner cartridge 21 to the drum unit 20 in an incorrect manner (a manner other than the correct attachment manner described above) with reference to FIGS. 11A to 11D.

First, an operation is described when the toner cartridge 21 is inserted into the installation space Sc1 of the drum unit 20 in an incorrect tilted posture with the right end side lower than the left end side (i.e., the right end side is inserted into the installation space Sc1 before the left end side), as illustrated in FIG. 11A.

In this case, the toner cartridge 21 is tilted with the right end side being positioned lower than the left end side thereof. Accordingly, as illustrated in FIG. 11D, at the right end side of the installation space Sc1, the right end portion of the regulation rib 54 provided at the right end of the toner cartridge 21 comes into contact with the upper end of the right end protrusion 33 of the drum unit 20, before the stopper 55, which is located closer to the center than the right end of the toner cartridge 21, would otherwise come in contact with the stopper release protrusion 37 of the drum unit 20.

In other words, when the toner cartridge 21 is tilted with the right end side being lower than the left end side, the position of the upper end of the right end protrusion 33, as seen from the stopper 55, is relatively lower than that when the toner cartridge 21 is not tilted. Therefore, the right end portion of the regulation rib 54 of the toner cartridge 21 comes into contact with the upper end of the right end protrusion 33 of the drum unit 20, preventing the stopper 55 from coming in contact with the stopper release protrusion 37.

In this manner, when the toner cartridge 21 is inserted into the installation space Sc1 in such an incorrect tilted posture with the right end side lower than the left end side, the insertion of the toner cartridge 21 is stopped at a predetermined position when the stopper 55 of the toner cartridge 21 approaches closer to but is not in contact with the stopper release protrusion 37 of the drum unit 20, as illustrated in FIGS. 11A to 11D. This position of the toner cartridge 21 is referred to as an incorrect insertion position or an incorrect position (see FIGS. 11A to 11D).

In the incorrect insertion position, as illustrated in FIG. 11B, at the left end side of the installation space Sc1, the left end protrusion 43 of the toner cartridge 21 rides on the left end protrusion 32 of the drum unit 20 (i.e., the left end protrusion 32 comes in contact with the lower end of the left end protrusion 43, which is a downstream end in the insertion direction), and therefore the left end groove 43G of the toner cartridge 21 and the left end protrusion 32 of the drum unit 20 are separated in the vertical direction. Also, in the incorrect insertion position, as illustrated in FIG. 11C, the toner supply port 41 is separated from the toner reception port 35 at the center side in the left-right direction of the installation space Sc1.

In this way, when the toner cartridge 21 is inserted into the installation space Sc1 of the drum unit 20 in the incorrect tilted posture with the right end side being lower than the left end side, the insertion of the toner cartridge 21 is stopped at the predetermined position (i.e., the incorrect insertion position), in which the regulation rib 54 of the toner cartridge 21 at the right end side of the installation space Sc1 comes into contact with the upper end of the right end protrusion 33 of the drum unit 20, and the left end protrusion 43 of the toner cartridge 21 comes into contact with the upper end of the left end protrusion 32 of the drum unit 20 at the left end side of the installation space Sc1. Therefore, the downward movement (the insertion movement) of the toner cartridge 21 is restricted, so as to prevent further insertion of the toner cartridge 21, resulting in an incorrect installation and incomplete installation. At the incorrect insertion position, the stopper 55 is separated away from and thus is not in contact with the stopper release protrusion 37.

Therefore, when the toner cartridge 21 is inserted into the installation space Sc1 in the incorrect tilted posture with the right end being lower than the left end, the stopper 55 does not come into contact with the stopper release protrusion 37, thereby the supply port shutter 42 cannot be moved to the open position by operating the operation lever 51. The operation that occurs when inserting the toner cartridge 21 into the installation space Sc1 of the drum unit 20 in such an incorrectly tilted posture, with the right end lower than the left end, is as described above.

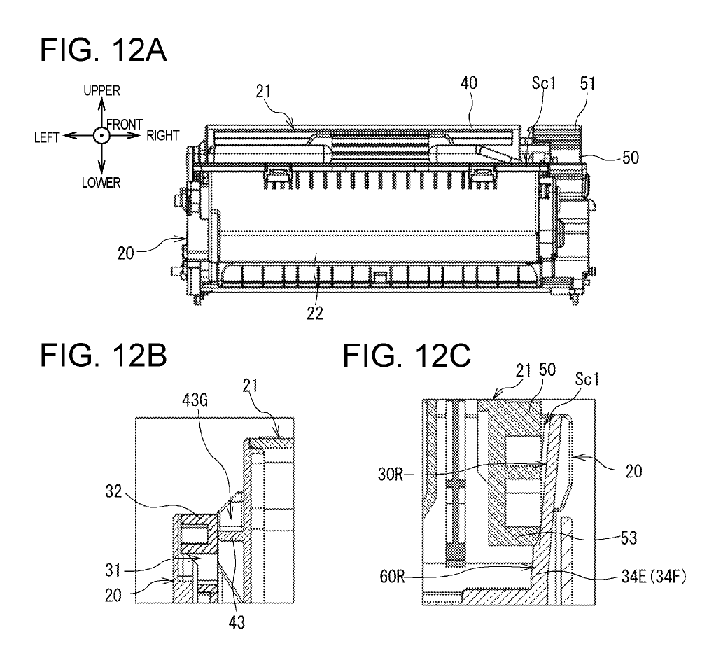

Next, an operation will be described when the toner cartridge 21 is inserted into the installation space Sc1 of the drum unit 20 in a substantially horizontal posture without tilting (i.e., a posture in which the left and right ends are inserted into the installation space Sc1 at substantially the same time), as illustrated in FIG. 12A.

In this case, as illustrated in FIG. 12B, at the left end side of the installation space Sc1, the toner cartridge 21 is inserted in such a manner that the left end of the left end protrusion 43 of the toner cartridge 21 contacts the right end of the left end protrusion 32 of the drum unit 20.

With this, the toner cartridge 21 is shifted toward the right end of the installation space Sc1 compared to the state illustrated in FIG. 9B, i.e., the state in which the left end protrusion 32 of the drum unit 20 is inserted into the left end groove 43G of the toner cartridge 21.

As a result, as illustrated in FIG. 12C, the toner cartridge 21 is inserted into the installation space Sc1 in such a manner that the right end of the rotation member 50 contacts the right wall surface 30R of the installation space Sc1. During this insertion, the lower end of the right end portion of the rotation member 50 comes into contact with the upper ends of the cartridge posture correction guides 34F and 34E, which protrude from the right wall surface 30R.

Note that the cartridge posture correction guides 34F and 34E are provided in front and rear of the right end protrusion 33, respectively, with the right end protrusion 33 located between the two guides. More specifically, the upper end of the cartridge posture correction guide 34F comes in contact with a portion of the right end portion of the rotation member 50 located in front of the rotation member groove 52, and the upper end of the cartridge posture correction guide 34E comes in contact with a portion, i.e., the rotation member engagement portion 53, of the right end portion of the rotation member 50 located in rear of the rotation member groove 52.

In this state, the toner cartridge 21 is restricted from moving downward at the right end side of the toner cartridge 21. On the other hand, the toner cartridge 21 is not restricted from moving downward at the left end side of the toner cartridge 21. Accordingly, the toner cartridge 21 is inserted into the installation space Sc1 while being tilted with the left end side being positioned lower than the right end side of the toner cartridge 21.

Then, the left end side of the toner cartridge 21 is lowered until the left end groove 43G of the toner cartridge 21 is located opposite the left end protrusion 32 of the drum unit 20. The toner cartridge 21 is then shifted to the left so as to insert the left end protrusion 32 into the left end groove 43G.

In this state, as the toner cartridge 21 shifts to the left, the lower end of the right end portion of the rotation member 50 at the right end side of the toner cartridge 21 comes off from the upper ends of the cartridge posture correction guides 34F and 34E, thereby releasing the restriction on the downward movement of the toner cartridge 21 at the right side. The subsequent operation proceeds in the same manner as when the toner cartridge is correctly installed as described above.

Note that, as illustrated in FIG. 12C, the left end surfaces 60 of each of the cartridge posture correction guides 34F and 34E provided on the right wall surface 30R of the installation space Sc1 may be inclined surfaces that are inclined so as to approach the left wall surface 30L as they extend downward, similar to the right wall surface 30R.

In such a case, when the toner cartridge 21 is inserted in an approximately horizontal posture without tilting, the right end portion of the rotation member 50 can move along the inclined right wall surface 30R of the installation space Sc1 and the inclined left end surfaces 60 of the cartridge posture correction guides 34F and 34E, guiding the toner cartridge 21 gradually toward the left side.

### 4. Effects

In an embodiment as described above, the image formation apparatus 1 includes the image formation unit 5 including the unit main body 22, which is an example of a main body of a development device, and the toner cartridge 21, which is an example of a developer cartridge, configured to be detachably attached to the unit main body 22.

The toner cartridge 21 has the substantially rectangular parallelepiped shape. The toner cartridge 21 includes: the toner supply port 41 provided on the underside 40B, which is one end side in the direction orthogonal to the longitudinal direction; the supply port shutter 42 configured to open and close the toner supply port 41, the stopper 55 provided on the underside 40B and configured to regulate the movement of the supply port shutter 42 from the closed position to the open position, the left end groove 43G provided on the left end side, which is one end side in the longitudinal direction; and the regulation rib 54 provided on the right end side, which is the other end side in the longitudinal direction. The toner supply port 41 is an example of a supply port configured to supply the toner as the developer. The supply port shutter 42 is an example of an opening/closing member. The stopper 55 is an example of a regulating portion that regulates the movement of the opening/closing member from the closed position to the open position. The left end groove 43G is an example of a first engagement portion. The regulation rib 54 is an example of a first contact portion.

The unit main body 22 includes: the toner reception port 35 serving as an example of a reception port; a left end protrusion 32 serving as an example of a second engagement portion; and the stopper release protrusion 37 serving as an example of a restriction release portion; and the right end protrusion 33 serving as an example of a second contact portion. The toner reception port 35 is provided at a position to connect with the toner supply port 41 when the toner cartridge 21 is attached to the unit main body 22, so as to receive the toner. The left end protrusion 32 is provided at a position opposite the left end of the toner cartridge 21. The left end protrusion 32 is provided at a position opposite the right end side of the toner cartridge 21 and is configured to engage with (i.e., to be inserted into) the left end groove 43G of the toner cartridge 21 when the toner cartridge is installed in the correct manner, namely, when the toner cartridge 21 is inserted in the tilted posture such that the left end side approaches the unit main body 22 before the right end side during attachment of the toner cartridge. The stopper release protrusion 37 is configured to come into contact with the stopper 55 and release the movement restriction of the supply port shutter 42 when the toner cartridge 21 is placed in the correct insertion position. The right end protrusion 33 is provided at a position oppose the right end side of the toner cartridge 21 and is configured to come in contact with the restriction rib 54 of the toner cartridge 21 so as to keep the stopper 55 and the stopper release protrusion 37 separated when the toner cartridge 21 is installed incorrectly, that is, when the toner cartridge 21 is inserted in the tilted posture such that the right end side approaches the unit main body 22 before the left end side during attachment of the toner cartridge.

According to the configuration described above, in the course of attachment of the toner cartridge 21 to the unit main body 22, when the toner cartridge 21 reaches the incorrect insertion position, that is, when the toner cartridge 21 is attached incorrectly, the supply port shutter 42 is prevented from opening. As a result, toner leakage from the toner supply port 41 and contamination of the area around the toner supply port 41 or the inside of the image formation apparatus 1 can be prevented. Therefore, the image formation unit 5 can reduce stains caused by the toner.

In addition, when the toner cartridge 21 reaches the incorrect insertion position in the incorrect tilted posture with the right end side approaching the unit main body 22 before the left end side in the course of attachment of the toner cartridge 21, the regulation rib 54 on the right end side of the toner cartridge 21 comes in contact with the right end protrusion 33 of the unit main body 22, thereby restricting movement of the right end side of the toner cartridge 21 in the attachment direction (insertion direction) of the toner cartridge (downward), and the left end protrusion 43, which serves as an example of a cartridge protrusion provided on the left end side of the toner cartridge 21, comes in contact with (rides over) the left end protrusion 32, which serves as an example of a main body protrusion, thereby restricting movement of the left end side of the toner cartridge 21 in the attachment direction (downward).

In this way, when the toner cartridge 21 reaches an incorrect insertion position in the course of attachment of the toner cartridge 21, the image formation unit 5 can prevent the toner cartridge 21 from being moved any further in the attachment direction, and allows the user to retry to install the toner cartridge 21.

Furthermore, the image formation unit 5 includes the cartridge posture correction guides 34F and 34E, which are an example of posture correction portions. The cartridge posture correction guides 34F and 34E are provided in the unit main body 22 at a position opposite the right end side of the toner cartridge 21. The cartridge posture correction guides 34F and 34E is configured, when the toner cartridge 21 is attached in an un-tilted posture (i.e., when the toner cartridge 21 is attached to the unit main body 22 in an posture in which the left and right end sides of the toner cartridge 21 approach the unit main body 22 at approximately the same time), the left end groove 43G provided on the left end side of the toner cartridge 21 engages with the right end side of the toner cartridge 21 before engaging with the left end protrusion 32 of the unit main body 22, and continues to engage until the left end groove 43G engages with the left end protrusion 32, thereby restricting movement of the right end side of the toner cartridge 21 in the attachment direction (downward) and tilting (i.e., correcting) the posture of the toner cartridge 21 so that the toner cartridge 21 reaches the correct insertion position.

In this way, even if an attempt is made to install the toner cartridge 21 in a non-tilted posture, the image formation unit 5 can tilt the toner cartridge 21 to the correct insertion posture during attachment of the toner cartridge 21, ensuring the toner cartridge 21 is properly attached.

### 5. Modifications

### 5-1. Modification 1

In one or more embodiments described above, the stopper 55 is made of an elastic member that is elastically deformable. However, in this disclosure, the stopper 55 is not limited to this and may be any member that can come into contact with the stopper release protrusion 37 and be pushed upward so as to be able to come off the stopper contact portion 44.

For example, the stopper 55 may be a member that is supported by the rotation member 50 to be movable in the vertical direction, and is configured to be held in a position in contact with the stopper contact portion 44 by its own weight or the biasing force of a biasing member such as a spring when the toner cartridge 21 is not attached to the drum unit 20, and configured to come into contact with the stopper release protrusion 37 and be pushed upward, thereby disengaging from the stopper contact portion 44, when the toner cartridge 21 is attached to the drum unit 20.

### 5-2. Modification 2

In one or more embodiments described above, the invention is applied to the image formation unit 5 in which the toner cartridge 21 is inserted into the installation space Sc1 from above the installation space Sc1 provided in the drum unit 20, that is, the image formation unit 5 in which the attachment direction of the toner cartridge 21 is downward. However, the invention is not limited thereto, and may be applied to an image formation unit 5 in which the toner cartridge 21 is attached a lateral or other direction.

For example, the invention may be applied to an image formation unit in which a drum unit is provided with an installation space that is open on the left side, and a toner cartridge is inserted into the installation space from the left side.

### 5-3. Modification 3

In one or more embodiments described above, the two of the cartridge posture correction guides 34F and 34E are provided on the unit main body 22 of the drum unit 20. The disclosure is not limited thereto. For example, in a modification, only one cartridge posture correction guide or three or more cartridge posture correction guides may be provided.

### 5- 4. Modification 4

In one or more embodiments described above, the invention is applied to an image formation unit 5, which includes the unit main body 22 of the drum unit 20 that is detachably attached (mounted) to the image formation apparatus 1, and the toner cartridge 21 that is detachable attached (mounted) to the unit main body 22. However, the disclosure is not limited thereto and may be applied to various image formation units that include a main body and a developer cartridge that is detachably attached to the main body.

For example, the disclosure may be applied to an image formation unit that includes an image formation apparatus main body and a developer cartridge that is detachably attached to the image formation apparatus main body. The disclosure may be also be applied to an image formation unit having a configuration in which a development device is fixed to an image formation apparatus main body and a developer cartridge that is detachably attached to the apparatus main body. Further, the disclosure is not limited to being applied to the image formation apparatus 1, but can be applied to various image formation apparatuses equipped with an image formation unit. Furthermore, the disclosure is not limited to the toner cartridge 21, but can be applied to various developer cartridges that are configured to detachably attachable to a main body.

### 5- 5. Modification 5

In each of one or more embodiments described above, the disclosure is applied to the image formation apparatus 1, which is the monochrome printer in which the toner cartridge 21 is configured to be detachably attachable. However, the disclosure is not limited to this, but can be also applied to various image formation apparatuses such as color printers, copiers, facsimile machines, and MFPs (Multi Function Peripherals) in which one or more developer cartridges are configured to be detachably attachable.

### 5- 6. Modification 6

Furthermore, the invention is not limited to one or more embodiments and modifications described above. That is, the application range of the invention covers embodiments obtained by arbitrarily combining some of or all of one or more embodiments and modifications described above.

The invention can be widely used in, for example, image formation apparatuses including a detachable toner cartridge.

The invention includes other embodiments or modifications in addition to one or more embodiments and modifications described above without departing from the spirit of the invention. The one or more embodiments and modifications described above are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An image formation unit comprising:
a main body; and a developer cartridge that is configured to be detachably attached to the main body, wherein
the developer cartridge comprises:
a supply port provided at one end side of the developer cartridge in an orthogonal direction orthogonal to a longitudinal direction and configured to supply a developer stored in the developer cartridge;
an opening/closing member configured to open and close the supply port;
a restriction portion provided on the one end side in the orthogonal direction of the developer cartridge and configured to restrict movement of the opening/closing member from a closed position to an open position;
a first engagement portion provided on one end side in the longitudinal direction of the developer cartridge; and
a first contact portion provided on the other end side in the longitudinal direction of the developer cartridge,
the main body comprises:
a reception port provided at a position where the reception port is connected to the supply port in a state where the developer cartridge is attached to the main body and configured to receive the developer from the supply port;
a second engagement portion provided at a position opposite the longitudinal one end side of the developer cartridge, the second engagement portion being configured to engage with the first engagement portion of the developer cartridge when the developer cartridge reaches a correct position during attachment of the developer cartridge to the main body;
a restriction release portion configured to release the restriction on movement of the opening/closing member by contacting the restriction portion when the developer cartridge reaches the correct position; and
a second contact portion provided at a position opposite the longitudinal other end side of the developer cartridge, the second contact portion being configured to contact the first contact portion of the developer cartridge when the developer cartridge reaches an incorrect position during attachment of the developer cartridge to the main body, thereby maintaining separation between the restriction portion and the restriction release portion.

2. The image formation unit according to claim 1, wherein
the correct position is a position where the developer cartridge reaches during attachment of the developer cartridge to the main body in such a manner that the developer cartridge is in a tilted posture, with the longitudinal one end side of the developer cartridge approaching the main body earlier than the longitudinal other end side of the developer cartridge.

3. The image formation unit according to claim 2, wherein
the correct position is the position where the first contact portion and the second contact portion come into contact with each other after the first engagement portion and the second engagement portion engages with each other.

4. The image formation unit according to claim 2, wherein
the incorrect position is a position where the developer cartridge reaches during the attachment of the developer cartridge to the main body in such a manner that the developer cartridge is in a tilted posture, with the longitudinal other end side of the developer cartridge approaching the main body earlier than the longitudinal one end side of the developer cartridge.

5. The image formation unit according to claim 4, wherein
the first engagement portion, provided at the longitudinal one end side of the developer cartridge, comprises a groove formed at a distal end side of a cartridge protrusion that projects in the longitudinal direction from the longitudinal one end side of the developer cartridge, and
the second engagement portion, provided at the main body, comprises a main body protrusion that is provided on the main body and is configured to be inserted into the groove from the distal end side of the cartridge protrusion.

6. The image formation unit according to claim 5, wherein
when the developer cartridge reaches the incorrect position, the main body protrusion comes in contact with a portion on a downstream side of the cartridge protrusion in the direction of attachment of the developer cartridge, so as to restrict movement of the longitudinal other end side of the developer cartridge in the attachment direction.

7. The image formation unit according to claim 5, wherein
the main body further includes a posture correction portion that is provided at a position opposite the longitudinal other end side of the developer cartridge, the posture correction portion being configured, upon attaching the developer cartridge to the main body in a posture such that the longitudinal one end side and the longitudinal other end side approach the main body at approximately the same time, to engage with the longitudinal other end side of the developer cartridge during attachment of the developer cartridge, so as to restrict movement of the longitudinal other end side of the developer cartridge in the attachment direction, thereby tilting the developer cartridge into the correct position.

8. The image formation unit according to claim 7, wherein
the posture correction portion is configured, when the first engagement portion of the developer cartridge and the second engagement portion of the main body are engaged with each other, to be released from engagement with the longitudinal other end side of the developer cartridge as the developer cartridge moves toward the second engagement portion of the main body.

9. The image formation unit according to claim 8, wherein
the second engagement portion is provided on an upstream side of the posture correction portion in the attachment direction of the developer cartridge.

10. The image formation unit according to claim 1, wherein
the main body is a main body of a development device configured to be detachably attached to an image formation apparatus.

11. An image formation apparatus comprising:
the image formation unit according to claim 1.

12. A developer cartridge that is detachable from a main body, comprising:
a supply port provided at one end side of the developer cartridge in an orthogonal direction orthogonal to a longitudinal direction and configured to supply a developer stored in the developer cartridge;
an opening/closing member configured to open and close the supply port;
a restriction portion provided on the one end side in the orthogonal direction of the developer cartridge and configured to restrict movement of the opening/closing member from a closed position to an open position;
a first engagement portion provided on one end side in the longitudinal direction of the developer cartridge; and
a first contact portion provided on the other end side in the longitudinal direction, wherein
the developer cartridge is configured, when the developer cartridge reaches a correct position during attachment of the developer cartridge to the main body, such that the first engagement portion engages with a second engagement portion provided on the main body and the restriction portion comes in contact with a restriction release portion provided on the main body to release the restriction on the movement of the opening/closing member, and the developer cartridge is configured, when the developer cartridge reaches an incorrect position during attachment of the developer cartridge to the main body, such that the first contact portion comes in contact with a second contact portion provided on the main body, to maintain separation between the restriction portion and the restriction release portion.
